(19) United States
(12) Patent Application Publication
(10) Pub. No.: US 2020/0259404 A1
(43) Pub. Date: Aug. 13, 2020

(54) HIGH FREQUENCY AC POWER GENERATOR

(71) Applicant: NEW YORK UNIVERSITY, New York, NY (US)

(72) Inventor: Francisco DE LEON, Bogota, NJ (US)

(21) Appl. No.: 16/785,424

(22) Filed: Feb. 7, 2020

Related U.S. Application Data
(60) Provisional application No. 62/803,293, filed on Feb. 8, 2019.

(51) Int. Cl. H02K 19/18; H02P 9/36; H02P 9/42

(52) U.S. Cl. CPC H02K 19/18; H02P 9/42; H02P 9/36

(57) ABSTRACT

A synchronous generator with high frequency AC excitation source.

### CROSS-REFERENCE TO RELATED APPLICATIONS

This application claims benefit of priority to U.S. Provisional Application No. 62/803,293 filed Feb. 8, 2019, which is incorporated herein by reference in its entirety.

### TECHNICAL FIELD

The present disclosure relates generally to systems and method for power generation, specifically to a generator utilizing high frequency AC excitation.

### BACKGROUND

Most power generation in the world is done with synchronous generators running at a frequency of 50 Hz or 60 Hz. While AC and DC technologies have their niches in various industries, the AC/DC battle between Edison/Westinghouse settled in favor of AC, effectively ending DC usage in utility-scale power generation and transmission. For AC systems, utilities experimented with several frequencies from 25 Hz to 133 Hz. With higher frequencies, smaller machinery (generators, transformers, motors) and larger cables are needed. In contrast, lower frequencies require larger machines with smaller cables, but flicker from incandescent bulbs was noticeable. As a compromise between the size of machines and cables together with the need to interconnect, 50 Hz was standardized in Europe. In North America, 60 Hz was selected to reduce flicker that was perceptible with the mercury rectifiers used at the time. Today, with the progress of power electronic switches and convertor configurations, there is a need and capability for more efficient alternatives to use a single frequency.

The new technology can be applied to conventional rotating generation technologies (hydraulic, steam, wind, gas, etc.). The first generator candidates to approach are wind turbines because of their relative lower power output. The reduced size and weight of the new generators will improve the deployment of wind turbines enabling longer blades, increasing their power output. Additionally, it would be possible to generate over a greater range of wind speeds, eliminating the need for complex gear boxes, alignment and supporting equipment. Full generation control can be achieved by simply adjusting the frequency of the exciting current. Existing technology is bulky and makes the installation of off-shore wind turbines complex and expensive.

In the electric power industry there is a push to generate electricity from renewable resources, wind and solar in particular, to reduce greenhouse emissions. If the generator proposed is successful, the impact to the energy generation market will be significant. This work will reduce the size, cost, and weight of generators, possibly facilitating larger wind-power penetration from off-shore installations. The design of larger output power wind turbines, utilizing smaller generators, reducing hanging weight, which enables increased turbine blade lengths that capture greater amounts of wind, would provide an increase in power output (perhaps to MW levels).

Thus, there is a need for a new technology that would reduce the physical size and weight of generators, providing significant cost reductions as well. The market for such a product would be broad, including any power utility with generator assets.

### SUMMARY

Embodiments described herein relate generally to a synchronous generator comprising a stator, a rotor in communication with the stator, and a three-phase high frequency alternating current source in communication with the rotor.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1A shows a standard rotor/stator construction; FIG. 1B shows a standard DC excitation construction for a rotor; FIG. 1C shows the measured voltage induced in device of FIG. 1B; FIG. 1D illustrates an embodiment utilizing a DC excitation source; FIG. 1E shows the show the measured voltage induced in device of FIG. 1D; FIG. 1F shows an embodiment with an ideal construction having a three-phase wound rotor that is excited by a three-phase high frequency DC source; and FIG. 1G shows the show the measured voltage induced in device of FIG. 1F.

FIGS. 2A-2D show different generator arrangements and flexible power system connections.

FIG. 3 illustrates a three-phase induction generator in accordance with one embodiment.

FIG. 4 illustrates a computer system for use with certain implementations.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION OF VARIOUS EMBODIMENTS

Embodiments described herein relate generally to excitation of the field winding of synchronous generators with high frequency AC instead of the traditional DC (or permanent magnets). Embodiments further describe a generator that utilizes a high frequency AC source. The excitation method may be extended to utility grade generators of all sizes. By exciting the rotor of a generator with high frequency AC the voltage induction process is more efficient and generators can be made smaller for the same power. In one embodiment further described herein, an wherein a high frequency alternating current source, such as a three-phase AC source, has a frequency in the range of 1 Hz to 6 kHz inclusive, for example 1 Hz to 500 Hz.

According to Faraday's Law the voltage induced in the armature of a rotating machine is given by: V=4.44 K Bm f A N, where K is the product of the pitch factor and coil distribution factor, Bm is the design (peak) flux density [T], f is the frequency [Hz] produced by the rotation of the field, A is the cross sectional area [m²], and N is the number of turns. Thus, when applying AC excitation, the voltage induction process is magnified since V is proportional to f. Therefore, for the same induced voltage, the size of a machine, determined by the number of turns N and the cross sectional area A, can be reduced in proportion to the excitation frequency as:

V=4.44K Bm(f)↑(A N)↓.

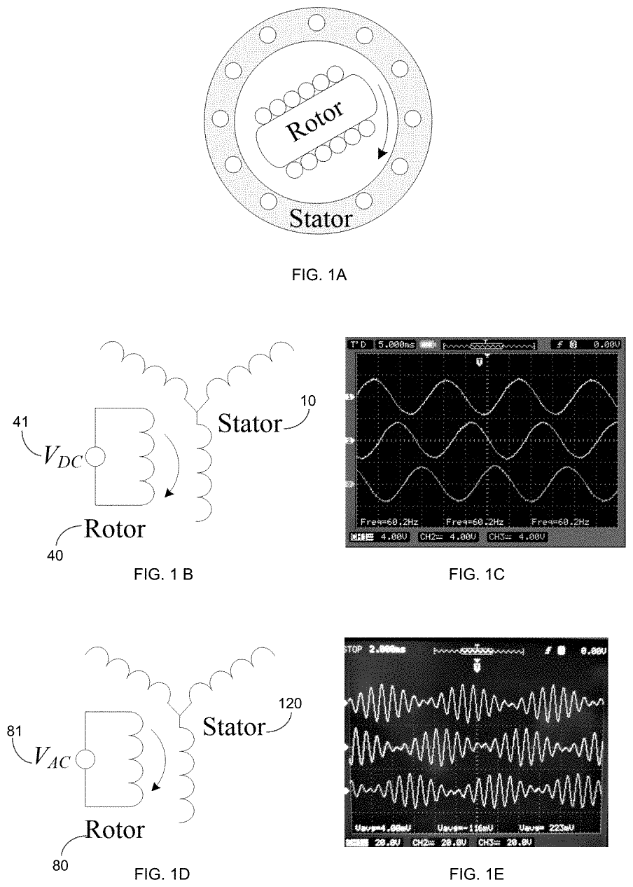

The prior art generators rely upon a DC source for excitation. FIG. 1A illustrates the construction of an example of a salient pole synchronous machine. FIG. 1B is a schematic showing the method most commonly used today to induce a 60 Hz voltage (FIG. 1C) comprising a stator 10 and rotor 40 using a DC excitation 41. The DC current is passed though the excitation winding attached to the rotor 40, which is then revolved on its axis to produce a time varying flux. Voltage is produced in the stator windings (i.e., the armature) and an output is provided in electrical communication with the stator. As an alternative excitation, permanent magnets are used in some gas/wind turbine generators.

In FIG. 1D one embodiment is show where the DC source is replaced with a single-phase high-frequency AC source 81. The use of an AC source 81 produces a modulated magnetic flux (high-frequency results in being over the 60 Hz envelope) as seen in FIG. 1E. One embodiment the rotor 140 is constructed as shown in FIG. 1F where a three-phase rotor winding 141 is energized from a high-frequency three-phase AC source 145. FIGS. 1C, 1E, and 1G represent the measured voltages for each one of the three generator alternatives of FIGS. 1B, 1D, and 1F, respectively, from lab experiments.

Each of FIGS. 1B-1G use 2 kVA machines. FIG. 1B shows that when using a four-pole synchronous generator rotating at a rated speed of 1800 rpm, the traditional DC excitation 41 induces a 60 Hz sinusoidal three-phase voltage (FIG. 1C). Substituting the DC source 41 for a single phase 1,000 Hz AC source 81, as shown in FIG. 1D, the measured terminal voltage of the same generator a modulated 1,000 Hz voltage with a 60 Hz envelope (FIG. 1E). Shown in FIG. 1G is the measured voltage induced in the stator 120 of the generator structure of FIG. 1F, which is a wound rotor 140 excited with a three-phase (2,000 Hz) AC source 145. As expected, the frequency of the voltage is the sum of the excitation frequency (2,000 Hz) and the rotation speed (60 Hz equivalent). This demonstrates that the desired induced high frequency voltage can be obtained from the proposed generator design. Notably, the single phase excitation, such as in FIGS. 1D-E, will produce a modulating double frequency terminal voltage and flux density. Thus, the maximum design flux density (and size reduction) will be reduced by the lower frequency. The three-phase excitation, such as shown in FIGS. 1F-G, eliminates the modulation.

In one embodiment, the construction of the high frequency AC machine 110 generally has several important differences over currently available wound rotor induction machines. Today standard wound-rotor machines need material suitable for 60 Hz in the stator and a few Hz for the rotor. As such, existing machines typically use iron-core material, for both stator and rotor. The described high frequency AC machine utilizes material suitable for high-frequency operation (1 Hz to 6 kHz region), such as described further below. The high frequency AC machine, as well as a standard wound-rotor machine, will typically need three slip-rings (one per phase) in comparison to a standard synchronous generator needing two.

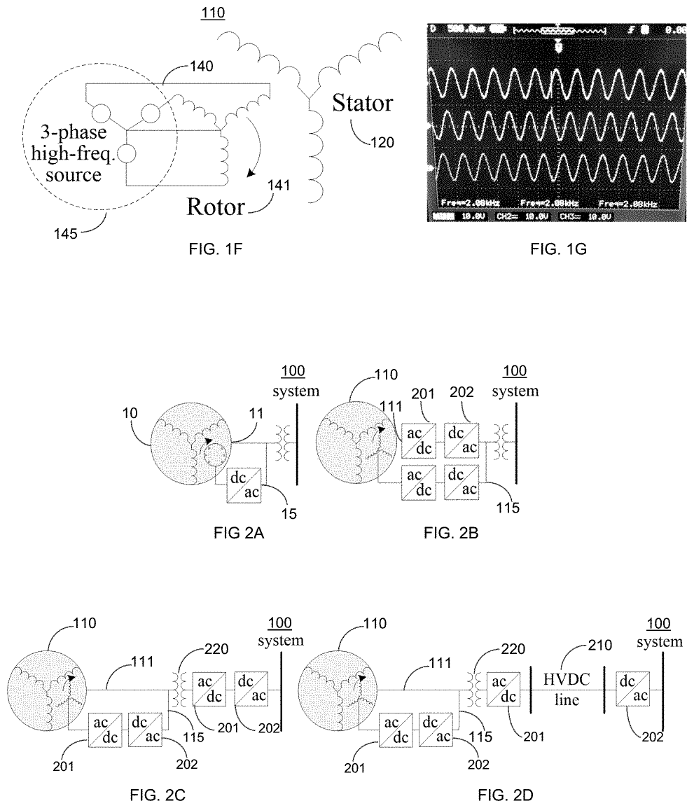

FIG. 2A shows the connection of a traditional synchronous generator 10 to a system 100. The generator 10 includes an output line 11 and an input line 15 for the electromagnet of the rotor. Often, at the terminals of a large power generator a step-up transformer is connected as shown.

FIGS. 2B-2D illustrate several designs of flexible power systems that can be achieved with a new (high-frequency) generator 110. The generator systems 110 described herein consist generally of a rotor 140 and stator 120, the rotor 140 being in communication with a prime mover, such as the rotational motion generated by a wind mill's blades. The rotor 140 is, in some embodiments, a wound rotor, such as with 120° spacings for 3-phase winding and excited by an 3-phase AC source 145. The stator 120 is the stationary component within which the rotor spins to generate the relative motion that drives current. The stator 120 is in communication with an output line 111, which may then be in communication with a series of transformers, convertors or other such devices before reaching the main system 110, which may be, for example, a power grid or an operational device. The rotor 140 includes an input line 115 to provide power to excite the rotor 141, for example the input line 115 may provide AC to the AC source 145. The input line 115 may be in communication with a series of transformers, convertors or other such devices to allow the energy provided to be converted to the high frequency AC for the AC source 145.

Magnetic materials capable of handling high frequency (in the low kHz range) must be used in certain embodiments of the generator to minimize the eddy current and hysteresis losses. Eddy currents are parasitic current induced in conducting materials, which produce losses and heat. All electrical machines must deal with them because ferromagnetic materials (the iron-core of all machines) necessary to magnify the magnetic field are also conductors. Therefore, eddy currents are induced where they are not desired (such as an iron-core). It should be appreciated that the higher the frequency, the more difficult it becomes (because of greater losses) to limit their effect. In 60 Hz machines, manufacturers use laminated steel with 3% silicon. For frequencies in the kilohertz region 6.5% silicon is used. For machines above a few kilohertz only ferrites work.

Embodiments of a high frequency AC machine 110 will include an appropriate material based on the frequency, for example 6.5% silicon-steel. Because of the small size, no special conductors are needed. Larger machines may need continually transposed conductors or Litz wire. The construction of embodiments of the high frequency AC synchronous machine is different from today's synchronous generators. The stator of todays' standard three-phase synchronous machines and induction machines is the same. Embodiments of the high frequency AC synchronous machine 110 may a similar stator. However, there are important differences in the rotor 140 and the operating principle of the high frequency AC synchronous machine is completely different. The high frequency AC synchronous machine 110 has some similarity to an induction machine, but because of the unique excitation (three-phase high-frequency), it operates as a synchronous machine.

FIG. 2B demonstrates the connection of the high-frequency generator 110. In the illustrated embodiment, it is assumed that the generator 110 will be receiving AC power at 60 Hz and that the same is the desired output, however it should be appreciated that these can be different frequencies and the input and output need not be the same. In the illustrated embodiment, the proposed small-size generator 110 may utilize one or more conversion links using AC-to-DC links 201 and DC-to-AC links, for example in one embodiment two DC-links: one to convert the 60 Hz AC input to DC and then to high-frequency AC as the AC source 145 to feed the exciter of the rotor 141 and another one to convert high-frequency AC output from the stator 120 armature to DC and then back to 60 Hz AC to interconnect with the 60 Hz system, or to whatever frequency is appropriate. In some embodiments, the rating of the DC-link of the excitation circuit is much smaller than the armature converters.

FIG. 2C displays an embodiment having a connection where the high-frequency generator 110 feeds a high-frequency step-up transformer 220 without the need of additional convertors. In this arrangement, the step-up transformer is also much smaller and less expensive than those in existing generation stations.

FIG. 2D reveals another embodiment having a connection for the high-frequency generator. Here the DC-link on the high side of the high-frequency step-up transformer is split with a High Voltage DC (HVDC) transmission line. The arrangement depicted in FIG. 2D allows transmitting the largest amount of power with reduced physical footprint and electrical losses.

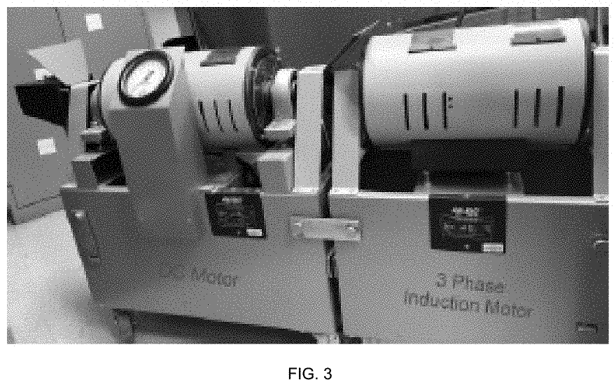

The operating principles of the proposed new generator have been demonstrated using two standard-built (60 Hz, 2 kVA) machines (see FIG. 3): a synchronous generator and a wound rotor three-phase induction machine. The experiments showed the expected high-frequency voltage induced at the machine terminals (see FIGS. 1A-1G).

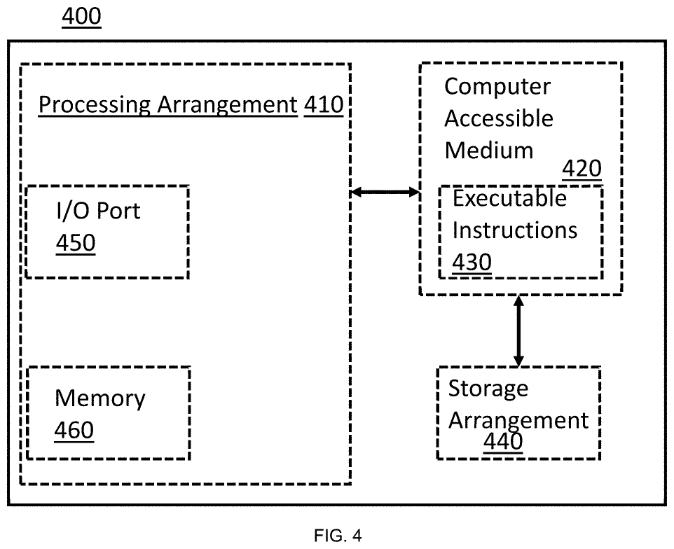

As shown in FIG. 4, for example, a computer-accessible medium 420 (e.g., as described herein, a storage device such as a hard disk, floppy disk, memory stick, CD-ROM, RAM, ROM, etc., or a collection thereof) can be provided (e.g., in communication with the processing arrangement 410). The computer-accessible medium 420 may be a non-transitory computer-accessible medium. The computer-accessible medium 120 can contain executable instructions 430 thereon. Additionally or alternatively, a storage arrangement 440 can be provided separately from the computer-accessible medium 420, which can provide the instructions to the processing arrangement 410 so as to configure the processing arrangement to execute certain exemplary procedures, processes and methods, as described herein, for example. The instructions may include a plurality of sets of instructions. For example, in some implementations, the instructions may include instructions for applying radio frequency energy in a plurality of sequence blocks to a volume, where each of the sequence blocks includes at least a first stage. The instructions may further include instructions for repeating the first stage successively until magnetization at a beginning of each of the sequence blocks is stable, instructions for concatenating a plurality of imaging segments, which correspond to the plurality of sequence blocks, into a single continuous imaging segment, and instructions for encoding at least one relaxation parameter into the single continuous imaging segment.

System 100 may also include a display or output device, an input device such as a keyboard, mouse, touch screen or other input device, and may be connected to additional systems via a logical network. Many of the embodiments described herein may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art can appreciate that such network computing environments can typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Various embodiments are described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, are intended to encompass implementations using one or more lines of software code, and/or hardware implementations, and/or equipment for receiving manual inputs.

As used herein, the singular forms “a”, “an” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed:

1. A synchronous generator comprising:
a stator;
a rotor in communication with the stator; and
a three-phase high frequency alternating current source in communication with the rotor.

2. The synchronous generator of claim 1, wherein the rotor comprises silicon-steel alloy.

3. The synchronous generator of claim 1, wherein the three-phase high frequency alternating current source has a frequency in the range of 1 Hz to 6 kHz.

4. The synchronous generator of claim 3, wherein the three-phase high frequency alternating current source has a frequency in the range of 1 Hz to 500 Hz.

5. The synchronous generator of claim 1, wherein the rotor is a wound rotor with equidistant three-phase windings.

6. A synchronous generator comprising:
a rotor; and
a three-phase high frequency alternating current source in communication with the rotor;
an input line in electrical communication with the three-phase high frequency alternating current source;
a stator in communication with the rotor and an output line in communication with an electrical system, the output line being in electrical communication with an input line.

7. The synchronous generator of claim 6, wherein the three-phase high frequency alternating current source has a frequency in the range of 1 Hz to 6 kHz.

8. The synchronous generator of claim 7, wherein the three-phase high frequency alternating current source has a frequency in the range of 1 Hz to 500 Hz.

9. The synchronous generator of claim 6, wherein the rotor is a wound rotor with equidistant three-phase windings.

10. The synchronous generator of claim 6, further comprising at least one AC-to-DC link and one DC-to-AC link.

11. The synchronous generator of claim 6 wherein the output further comprises an AC to DC link in communication with a high voltage DC line connected to a DC to AC link.

12. The synchronous generator of claim 6, wherein the input line includes an AC to DC link and a DC to a 1 Hz to 6 kHz AC link in communication with the three-phase high frequency alternating current source.

13. The synchronous generator of claim 12 wherein the output line further comprises a 1 Hz to 6 kHz AC link to DC link and an DC to a 60 Hz AC link.

14. The synchronous generator of claim 12, further comprising an AC to DC link in communication with a high voltage DC line connected to a DC to AC link.
